(19) United States
(12) Patent Application Publication
(10) Pub. No.: US 2006/0158324 A1
(43) Pub. Date: Jul. 20, 2006

(54) System and method to facilitate idetifying location of a remote module

(75) Inventor: Bradley Allen Kramer, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/029,096

(22) Filed: Jan. 4, 2005

(51) Int. Cl. B60C 23/00; B60R 25/10; G08C 19/00

(52) U.S. Cl. 340/447; 340/825.72; 340/426.17

(57) ABSTRACT

Systems and methods are disclosed to facilitate identification of a tire pressure sensing module in a tire pressure monitoring system. In one embodiment, a tire pressure sensing module includes a receive detector coupled to monitor a radio-frequency signal received by an antenna. The receive detector provides a detection signal if the received signal has at least a predetermined amplitude. The module also includes at least one sensor operative to sense a condition associated with a tire. A transmitter is coupled to provide a transmit signal via the antenna. A control system controls the transmitter to transmit the transmit signal to include at least the identifying data in response to the detection signal.

### TECHNICAL FIELD

This invention relates generally to a system and method to facilitate identifying the location of a remote module.

### BACKGROUND

The federal government has enacted the Transportation Recall Enhancement, Accountability, and Documentation (TREAD) Act. The TREAD Act proposes to require that certain passenger vehicles eventually be equipped with a tire pressure monitoring system (TPMS). There are two basic types of TPMS's, direct TPMS's and indirect TPMS's. A direct TPMS includes a tire pressure sensor in each tire. The sensors transmit pressure information to a receiver. In contrast, an indirect TPMS does not have tire pressure sensors. Current indirect TPMS's rely on the wheel rotational speed sensors in an anti-lock braking system (ABS) to detect and compare differences in the rotational speed of a vehicle's wheels. Those differences correlate to differences in tire pressure because decreases in tire pressure cause decreases in tire diameter that, in turn, cause increases in wheel rotational speed.

One issue related to direct TPMS systems concerns the identification of which tire pressure module is (or modules are) transmitting at a given time. By way of example, in a typical TPMS, a tire pressure module (TPM) is located inside each tire and one or more receivers are located on a chassis of a vehicle. Each TPM can include an identifier or code that enables the central processing system to distinguish between each respective TPM. The central processing system can map the identifier or code to an associated tire location to ascertain which tire location a received signal should be associated for describing a tire condition provided in the received signal. Accordingly, if one of the tires is replaced or if the tires are rotated, the central processing system should be updated to reflect the new location of each of the TPM's.

### SUMMARY

The present invention relates to a system and method to facilitate identifying location of a remote module.

One aspect of the present invention provides a tire pressure sensing module. The module includes a receive detector coupled to monitor a radio-frequency signal received by an antenna. The receive detector provides a detection signal if the received signal has at least a predetermined amplitude. The module also includes at least one sensor operative to sense a condition associated with a tire. A transmitter is coupled to provide a transmit signal via the antenna. A control system controls the transmitter to transmit the transmit signal to include at least the identifying data in response to the detection signal.

Another aspect of the present invention relates to a tire pressure monitoring system. The system includes a plurality of tire pressure sensing modules. Each of the plurality of tire pressure sensing modules includes a receive detector that provides a detection signal if a radio frequency signal received by an associated antenna has at least a predetermined amplitude. At least one sensor is operative to sense a condition associated with a tire, and a transmitter is coupled to provide a transmit signal for radio-frequency transmission via the antenna. Each module also includes a control system that controls the transmitter to transmit the transmit signal to include at least the identifying data in response to the detection signal. The tire pressure monitoring system also includes a central system. The central system includes a receiver that receives the transmit signal from each of the plurality of tire pressure sensing modules. The central system also includes memory that stores identifying data associated with of vehicle tires during a learning mode based on the transmit signal received from each of the plurality of tire pressure sensing modules.

Yet another aspect of the present invention relates to a system to facilitate identifying a tire pressure sensing module in a tire pressure monitoring system. The system includes means for receiving a signal at a tire pressure sensing module that is operative to sense a condition of a tire. The system also includes means for transmitting identifying data from the tire pressure sensing module in response to the received signal having at least about a predetermined amplitude indicating operation in a learning mode. The system also includes means for receiving the transmitted identifying data at a central system of the tire pressure monitoring system. The system also includes means for storing an indication of the identifying data associated with the tire based on the identifying data received from the tire pressure sensing module.

Another aspect of the present invention provides a method to facilitate identifying a tire pressure sensing module in a tire pressure monitoring system. The method includes receiving a signal at a tire pressure sensing module that is operative to sense a condition of at least one tire. Identifying data is transmitted by the tire pressure sensing module if the received signal has at least a predetermined amplitude corresponding to a learning mode. The transmitted identifying data is received at a central monitoring system and an indication of the identifying data is set as being associated with the at least one tire based on the identifying data received from the tire pressure sensing module.

### BRIEF DESCRIPTION OF THE DRAWINGS

FIG. 1 depicts an example of a tire pressure module according to an aspect of the present invention.

FIG. 2 depicts an example of part of a tire pressure module that can be implemented according to the present invention.

FIG. 3 depicts an example of a detection system for use in a tire pressure module according to an aspect of the present invention.

FIG. 4 depicts an example of a tire pressure and monitoring system that can be implemented according to an aspect of the present invention.

FIG. 5 depicts an example of a flow diagram for a method for identifying a given tire pressure module according to an aspect of the present invention.

FIG. 6 depicts an example of a flow diagram for a method depicting a flow diagram of a method of controlling operation of a tire pressure monitoring system according to an aspect of the present invention.

### DETAILED DESCRIPTION

FIG. 1 depicts an example of a tire pressure module (TPM) 10 that can be implemented according to an aspect of the present invention. The module 10 includes a control system 12 that is operative to control the module 10. The control system 12 is coupled to a sensor 14 that is operative to sense at least one associated condition of a tire. For example, FIG. 1 depicts the sensor 14 as a pressure/temperature sensor 14 that is operative to sense a corresponding pressure and/or temperature condition associated with a tire in which the module 10 is utilized. Those skilled in the art will understand other types of tire condition sensors that can be utilized in the system 10, such as may monitor one or more internal as well as external conditions of the tire.

The module 10 can also include a timer 16 that is employed to synchronize and time operation of different functions implemented by the module 10. The timer 16 provides a timer signal to the control system 12 based on which the control system can control the pressure/temperature sensor 14 as well as other components of the module. For example, the control system 12 is operative to periodically (or intermittently) activate the pressure/temperature sensor 14 to sense the associated condition of the tire and store such information as DATA 16. The control system 12 can also store identification (ID) information 18 for the module 10. The identification information 18 is operative to uniquely identify the module 10 apart from other modules in a corresponding TPMS of a vehicle or nearby vehicles. The ID information 18 can be fixed for a given module 10 or it can be programmable.

The control system 12 is operative to control a transmitter 20 to provide transmit a signal to an associated antenna 22. The transmitted signal can be received by an associated receiver (not shown), such as may form part of central control and monitoring circuitry of the TPMS. The particular information encoded in the transmitted signal can vary depending on an operating mode of the module 10. For instance, the transmitter 20 can provide the signal encoded with an indication of the DATA 16 as well as the ID information 18. The control system 12 can operate the transmitter 20 in this manner at a predetermined time interval based on the value provided by the timer 16. Those skilled in the art will understand and appreciate various operating modes in which the module 10 can operate to control the timing interval in which the pressure/temperature sensor 14 is activated to obtain and store the data as well as the interval in which the transmitter 20 is activated. The respective time intervals for activating the transmitter 18 and the sensor 14 in a given operating mode can be the same or they can be different.

The module 10 also includes a receive detector 24 that is coupled to detect a signal received at the antenna 22. The antenna 22 can be implemented as including impendence matching for the associated network of the transmitter 18 and receive detector 24 to which the antenna 22 is coupled. The receive detector 24 can be implemented as a low power receiver that operates at a frequency that is the same or near the frequency utilized by the transmitter 20. As a result, the same antenna 22 can be utilized for both the transmitter 20 and the receive detector 22. For example, the transmitter 20 and the receive detector 24 can operate to transmit and receive signals via the antenna 22, respectively, modulated in the ultra high frequency (UHF) range (e.g., about 400 MHz to about 500 MHz), such as is commonly utilized for remote keyless entry systems in vehicles.

The receive detector 24 can be implemented as a low power receiver that receives its power from an associated power supply 26, such as a battery within the module. The power supply 26 also provides power to other components of the module 10. The receive detector can be implemented as a low power or limited dynamic range receiver that operates in a continuous mode without significantly affecting battery life of the power supply 26. For example, the receive detector 24 can be implemented as a traditional detector circuit that operates at reduced power compared to other more accurate receiver technologies. As used herein, the receive detector 24 can implemented as having a low sensitivity, which is characterized as a minimum power (in dB) that guarantees a particular bit error rate or as a function of the noise figure associated with the receive detector. Those skilled in the art will understand and appreciate various receive detector approaches (e.g., a diode envelope detector) that can be utilized based on the teachings contained herein that will afford a desired low power consumption and thereby improve lifetime of the power supply 26.

The receive detector 24 provides a detection signal to the control system 12 if a signal is received at the antenna 22 has at least a predetermined amplitude level. The predetermined amplitude level can be fixed as a function of the receive detector 24 design or it can be programmable to mitigate erroneous activation. When the received signal has at least the predetermined amplitude, the receive detector is triggered to provide the detection signal to the control system 12. The receive detector 24 can provide the detection signal as a single bit or a multi-bit signal based on the amplitude of the received signal. The amount of discrete data that can be represented in the detection signal can be set based on the capabilities of the control system 12.

The control system 12 is operative to activate the transmitter 20 in response to the detection signal indicating that the received signal has at least the predetermined amplitude level corresponding to a learning mode. The control system 12 controls the transmitter to provide at least the ID information 18 to the antenna 22 for transmitting a corresponding signal to the associated receiver, such that the ID information can be mapped to the respective tire with which the module 10 is associated. Additionally, the control system 12 can provide the data 16 as well as other information associated with the module 10 for transmission by the transmitter 20 in response to the detection signal from the receive detector 24.

By way of further example, as part of a calibration or learning mode to identify locations of modules in a TPMS, a user can place a portable transmitter device (e.g., a key FOB of a remote keyless entry system) 30 near the antenna 22 and then activate the portable transmitter, such as by pressing one or more buttons 32. The portable device can be configured for use with the TPMS or it can correspond to activation of an existing transmitter, such as a key fob. Those skilled in the art will understand and appreciate that many types of TPMS systems transmit at the same frequency (e.g., UHF) as a remote keyless entry system in order to require only one receiver on the chassis of the vehicle. The receive detector 24 can be configured to detect the signal from the portable device 30 provided that the portable device 30 is sufficiently close to the antenna 22 when activated.

As an example, the predetermined amplitude can be set to require that portable transmitter be positioned within a predetermined distance of the antenna 22 to enable the receive detector 24 to provide the detection signal. To mitigate interference with other tires, assuming the same operating frequency, the predetermined distance should be substantially less than one-half the distance to a closest adjacent other tire pressure sensing module. Alternatively, different buttons 32 can be associated with activating different modules in the TPMS of the vehicle, with each button encoding different data in the signal transmitted thereby or transmitting at a different frequency for each button.

The antenna 22 of the module 10 can be located near (e.g., operatively coupled to) the valve stem of a vehicle tire when the module is mounted in the tire. Accordingly, to ensure consistent activation in the calibration or learning mode, the portable transmitter 30 can be placed near or in contact with the valve stem in order to transmit a signal of sufficient amplitude to trigger the receive detector 24.

In the calibration mode, the control system 12 can be programmed to wake up in response to the detection signal from the receive detector 24 and in turn activate the transmitter 20 to provide the unique ID information 18 back to the receiver of the central processing system on the chassis of a vehicle. A similar process would be repeated for each tire on the vehicle, the order for which can be prompted by a user interface device of the central processing system during the calibration mode. As yet another alternative, a high power transmitter on a chassis of a vehicle can be utilized to transmit a high power calibration signal near or at the same frequency utilized by the transmitter 20 in each of the plurality of modules.

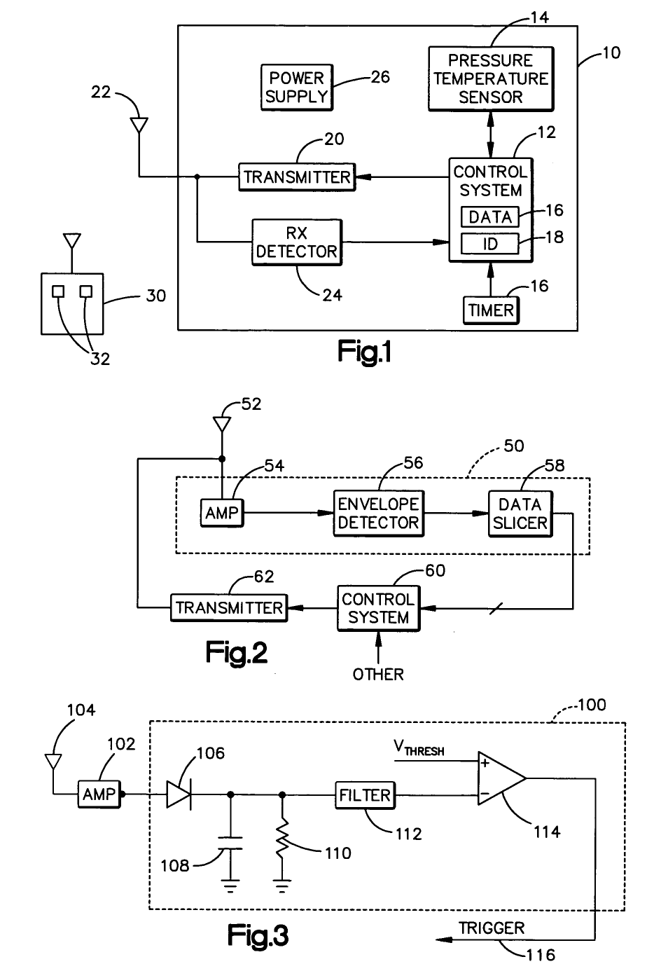

FIG. 2 depicts an example of part of an identification system 50 that can be utilized in each remote module of a tire pressure and monitoring system to facilitate identifying the location of a given module. The system 50 includes an antenna 52 that is impedance matched to the system 50. The antenna 52 is coupled to a receive amplifier 54 that provides an amplified version of the received signal to an envelope detector 56. The envelope detector 56 can correspond to any circuitry operative to remove the radio frequency (RF) component from the amplified version of the signal received at the antenna 52. For example, the envelope detector can provide a voltage shifted representation of the signal provided by the amplifier 54, such as within a predetermined voltage range.

A data slicer 58 receives the voltage shifted signal from the envelope detector 56 and identifies one or more bits of a corresponding data frame. The data slicer 58, for example, includes a threshold that determines whether a corresponding data bit will be asserted as a function of the analog output signal from the envelope detector 56. The threshold can be set to a predetermined level that controls the sensitivity of the detector 50. In one simple implementation, which is suitable for implementing the system 50, the data slicer 58 provides a single bit output signal to an associated control system 60. The signal from the data slicer 58 operates to trigger the control system 60 to operate an associated transmitter 62 to transmit a corresponding signal via the antenna 52, such as to identify the module within a TPMS. Alternatively, the data slicer 58 can include a plurality of subranges that are set to define a multi-bit output signal as data representing the more than two discrete amplitude ranges for the voltage shifted representation of the received signal.

The signal provided by the transmitter 62 includes identification information associated with the module corresponding to the system 50 depicted in FIG. 2. For example, the identifying data can correspond to an identifier or code associated with the module so that the corresponding receiver can distinguish between signals received from a plurality of such modules. Those skilled in the art will understand and appreciate by setting an activation threshold of the data slicer 58 at a sufficiently high predetermined voltage level, the receive detector system 50 will require at least a minimum amplitude level of a received signal to generate a trigger signal to cause the transmitter 62 to provide the identifying data in a learning mode. In addition to requiring a minimum amplitude for the received signal, the control system 60 can attribute different information to the signal based on a frequency or number of signal pulses received by the receive detector in predetermined time period. For instance, one long signal pulse can be utilized to cause the system to operate in one mode while one or more short duration signal pulses can be utilized to indicate a different mode. The differentiation between such information can be determined by the data slicer 58 or by the control system 60.

In order to provide the signal to the antenna 52 at a sufficient amplitude level, a portable transmitter device (e.g., a key-FOB of a keyless entry system (not shown)) can be utilized by activating a transmitter portion thereof when the device is in close proximity to the antenna 52. By close proximity, the device may need to be within inches or in contact with a valve stem to which the tire pressure sensing module is connected, or as otherwise as described herein. By requiring a predetermined amplitude level to trigger the control system 60 to provide the identifying data and activate the transmitter 62, extraneous noise sources as well as from general operation of the key-FOB will not result in erroneous activation of the transmitter 62. Those skilled in the art will understand and appreciate that additional cost efficiency can be achieved by having the receive detector system 50 and the transmitter 62 share the antenna 52 as well as by operating both receive and transmit paths at the same frequency or within a frequency band associated with the antenna.

FIG. 3 depicts an example of a trigger generator system 100 that can be implemented in a tire pressure sensing module to facilitate identification of the module. The trigger generator system 100 receives an input signal, which in the example of FIG. 3 is depicted as coming from an amplifier 102 that receives an RF signal from an associated antenna 104. The amplified RF input signal is provided to a corresponding RF diode 106 that operates generally as a rectifier to pass voltage that varies as a function of the received signal to downstream portions of the trigger generator system 100. The diode 106 can be arranged in the system 100 to pass positive voltage, as shown in the arrangement of FIG. 3, or it could be configured to pass negative voltage.

In the example of FIG. 3, the downstream portion includes a capacitor 108 and a resistor 110 connected in parallel between the cathode of the diode 106 and electrical ground. The capacitor 108 and resistor 110 are configured to provide a voltage shifted version of the input signal to the diode 106 corresponding to an envelope of the amplified RF signal. That is, the diode 106 and capacitor 108 and resistor 110 form a diode detector circuit. Those skilled in the art will understand and appreciate other variations of diode detectors and envelope detectors that can be utilized to detect a high power receive signal that can be utilized to activate an identification mode for the module implementing the system 100. A filter 112 can also be provided to filter out RF components and noise from the voltage shifted signal and provide a corresponding filtered version thereof to an input of a comparator 114. A corresponding threshold voltage (V_{THRESH}) is provided to another input of the comparator 114. The V_{THRESH} can be fixed or variable and can be programmable to set the threshold of the system 100.

The comparator 114 provides a corresponding TRIGGER signal based on the respective input signals, generally indicating whether the filtered voltage shifted signal exceeds V_{THRESH}. The comparator 114 can be biased to provide a single bit output at a corresponding voltage level (e.g., either at 0 V or at V_{CC}) based on the relative amplitude of the signals provided at the respective inputs of the comparator. For example, when the filtered voltage shifted signal exceeds the V_{THRESH}, the comparator 114 can provide a corresponding TRIGGER signal to a control system to trigger transmission of associated identification information. In contrast, if the filtered voltage shifted signal does not exceed the V_{THRESH}, the comparator 114 provides the TRIGGER signal in a different state (or value) so as not to activate transmission of the identification information.

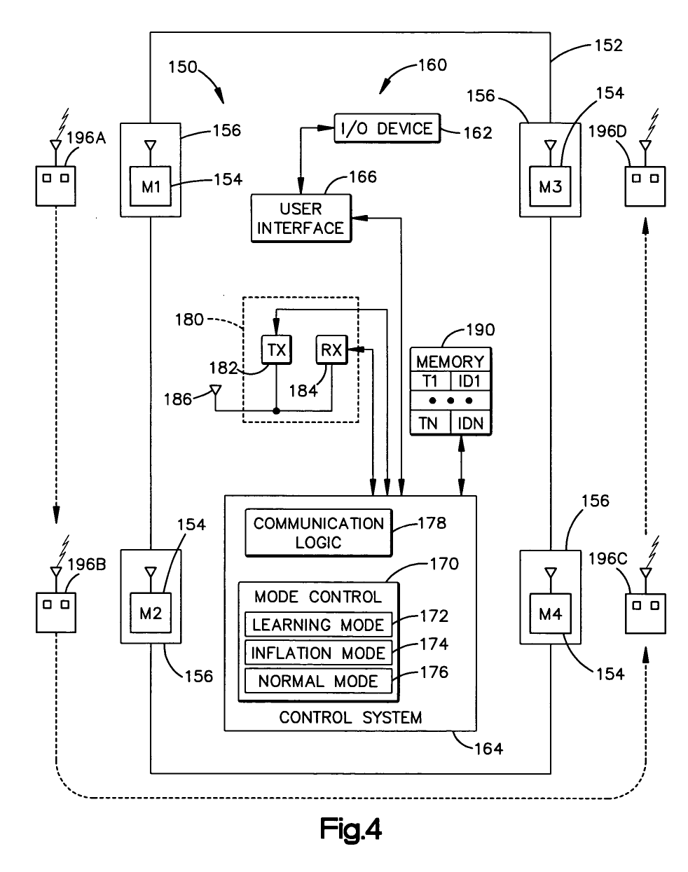

FIG. 4 depicts an example of TPMS 150 implemented in a vehicle 152 according to an aspect of the present invention. The system 150 includes a plurality of tire pressure sensor modules 154 (indicated at M1, M2, M3 and M4) associated with each of a plurality of tires 156. While four sensor modules 154 are depicted in the TPMS 150 of FIG. 4, it will be understood that any number of modules can be utilized in a TPMS according to an aspect of the present invention. Each of the tire pressure sensor modules 154 can be configured according to any of the embodiments shown and described herein (e.g., see FIGS. 1, 2, 3 and 5). Thus, each of the modules 154 includes a transmitter and a receive detector. The receive detector shares an antenna with the transmitter corresponding to detect a signal having at least a predetermined amplitude level for triggering transmission of a signal carrying at least identification information, such as part of a learning or calibration mode for the TPMS 150.

The TPMS 150 also includes a central control and monitoring system 160. The central system 160 includes at least one input/output (I/O) device 162 through which a user can interface with the TPMS, such as for entering instructions for controlling operation of the system as well as for providing information to the user, such as in a text- or graphical-based format on an associated display. Those skilled in the art will understand and appreciate that various types of I/O devices 162 that can be utilized as a central console for the system 150. Alternatively, the I/O device 162 could be a remote keyless entry fob or other portable I/O device for the vehicle 152. The I/O device 162 is coupled to a control system 164 through an associated user interface 166. The user interface 166 includes circuitry that is programmed and/or configured for communicating instructions and information between the I/O device 162 and the associated control system 164. The control system 164 includes mode control logic 170 that is operative to control the operating mode of the central system 160. The control system 164 and the mode control logic 170 can be implemented, for example, as a state machine or as a microcontroller programmed and/or configured to implement desired functions associated with a plurality of modes that can be utilized for implementing the TPMS system 150. In the example of FIG. 4, and for purposes of simplicity of explanation, the mode control 170 is illustrated as including a learning mode 172, an inflation mode 174 and a normal mode 176.

The control system 164 also includes communication logic 178 that is coupled to a transceiver system 180. The transceiver system 180 can include a transmit portion (TX) 182 and a receive (RX) portion 184. The transceiver system 180 thus is operative to transmit and receive wireless signals via one or more associated antennas 186. For example, the central system 160 can include a single antenna for transmitting and receiving data over a corresponding frequency range. Alternatively, a plurality of antennas, such as one associated with each of the respective sensing modules 154 can be located in close proximity to the respective sensor modules so as to reduce power requirements in the transmissions made by such transmitters. It will be appreciated that the system 180 could alternatively be implemented as including only the receive portion 184.

The central system 160 can also include memory 190 that is associated with the control system 164. The memory 190 includes at least a plurality of entries or fields that are programmable to identify the location of the respective tire pressure modules 154 at each associated tire 156. For example, the memory 190 can include a data structure that includes entries for each of the respective tires, indicated at T1 through TN, where N is a positive integer denoting the number of tires for the vehicle. N can be set to include one or more spare tires as well as those mounted on wheels of the vehicle. Additionally, identification data, indicated at ID_1 through ID_N, can be associated with each tire entry T1 through TN. The identification data ID_1 through ID_N can correspond to the identifying data or a bit-mapped representation thereof for each of the respective modules 154. In this way, the control system 154 can employ the mapping of the identification data ID_1 through ID_N to a corresponding tire T1 through TN to facilitate providing tire condition information for a given tire 156 in response to receiving tire pressure data and identification information from a respective module 154.

By way of example, a user can employ the I/O device 162 to provide instructions to the central system 160 to initiate the learning mode 172. The mode control block 170 thus employs program instructions in the learning mode 172 to provide appropriate instructions through the user interface 166 and to the corresponding I/O device 162 to assist the user in programming the memory 190 of the central system 160 with proper location information for the modules 154. The user can employ a portable device 196 that can be positioned in close proximity to each antenna of the modules 154 or in contact with the respective tires 156 as specified or predetermined by the central system 160. The portable device 196 can transmit a signal at a frequency and amplitude sufficient to trigger transmission by each respective module 154. The transmission includes identifying data that is received and processed by the central system 160 to program the memory 190 with the identifying data for each of the respective modules 154.

In one particular example of FIG. 4, the portable device 196 is positioned adjacent to each tire 156 and activated to transmit a signal that, due to its proximity to each module 154 when activated, triggers each respective module to transmit a signal that is received by the central system 160. For purposes of illustration, the portable device 196 is moved along the dashed lines in an order through respective positions 196A, to 196B, to 196C and 196D (wherein the letters following “196” denote different positions utilized to trigger the respective modules 154 during the learning mode). Those skilled in the art will understand and appreciate that any known order can be utilized in programming the central system 160 with the identifying data associated with each of the modules 154. The signals transmitted by each of the modules 154, in response to being triggered by a signal received from the portable device 196, include identifying data encoded in a signal that is received at the receiver 184. The identifying information is decoded and provided to the control system 164 for programming the memory 190 accordingly.

Since the control system 164 knows which module should be transmitting at a given time based upon the information provided via the I/O device in the learning mode 172 (e.g., audible and/or visual information to the user), the identifying data transmitted by the module 154 can be programmed in the memory 190 as corresponding ID data locations associated with each tire data field T1 through TN. Additionally, after the identification data has been programmed for a respective tire T1 through TN, a further indication (e.g., audible and/or visual indication) can be provided via the user interface 166 to instruct the user to advance to the next location. The audible and/or visual information provided to the user as part of the learning mode can be provided via a console in the vehicle or by activating other vehicle components, such as headlights, tail lights or horn. The learning mode continues until identifying data has been programmed in the memory 190 for each of the tires T1 through TN or until the learning mode times out. After the learning mode has been completed, the mode control block 170 can transition to another operating mode such as the normal operating mode 176.

As another alternative mode, the mode control block 170 can enter into the inflation mode 174, such as by entering appropriate user instructions via the I/O device 162. The inflation mode, for example, can cause the communication logic 178 to control the transmitter 182 to transmit a high power broadcast signal that is received at the respective modules 154. The high power signal can be maintained for a predetermined time period or operate in the predetermined pattern (e.g., a series of pulses) or provide sufficient data to enable each of the respective modules 154 to enter a corresponding inflation mode. As an alternative to the high power transmission, a signal can be transmitted by a remote keyless entry fob or other portable device for the vehicle 152, which is positioned in close proximity to each respective tire for entering the inflation mode. The modules 154 can remain in the inflation mode for a predetermined time period or can exit the inflation mode in response to an additional subsequent high power broadcast by the central system 160 or by local transmission from a remote keyless entry fob for each respective tire.

Once in the inflation mode, each of the respective modules 154 is operative to transmit periodically or intermittently at a short time interval (e.g., every second or less). Each transmission can include sensed condition (e.g., pressure and/or temperature) data and identifying data for the respective module 154. The central system 160 receives the sensed condition data and the corresponding identifying data for the respective modules 154. The central system 160 in turn provides information through the user interface 166 to the I/O device 162 or to other vehicle components to inform the user of a substantially instantaneous indication of pressure for each of the respective tires or at least that tire which is experiencing a change in the pressure. Those skilled in the art will understand and appreciate various ways in which the respective transmitter modules 154 can operate during the inflation mode to provide timely information to assist the user in inflating the tires 156. Additionally, those skilled in the art will appreciate various means (e.g., audio, visual or a combination of audio-visual) that can be employed to provide pressure information to the user.

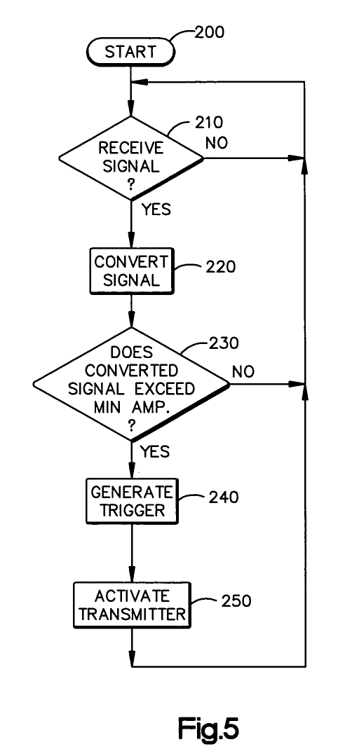

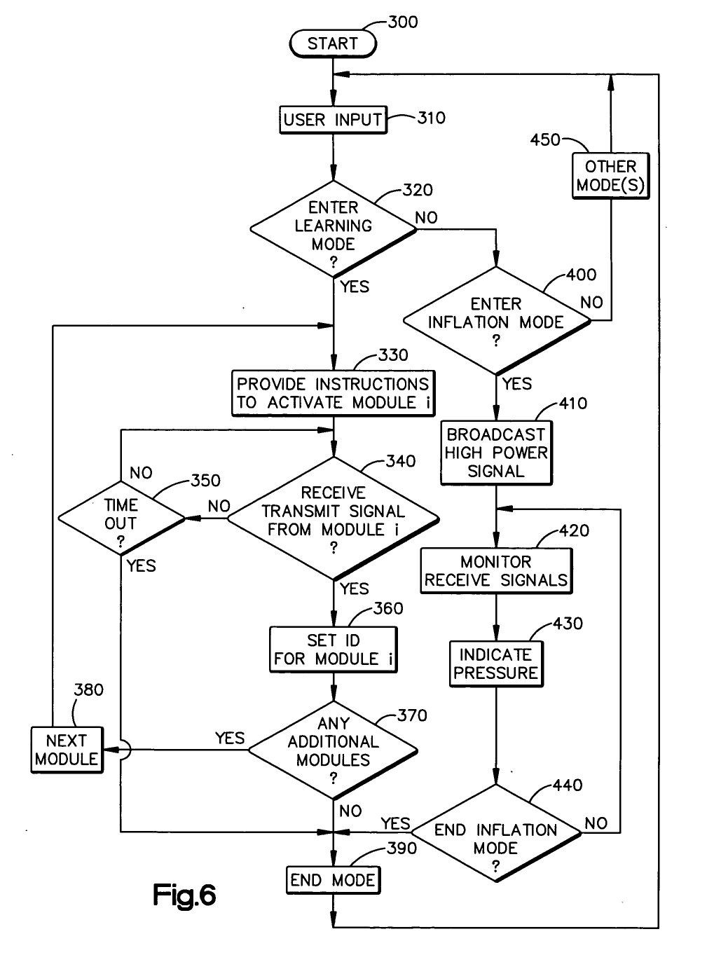

FIGS. 5 and 6 depict methods that can be performed by TPMS's according to an aspect of the present invention. While, for purposes of simplicity of explanation, the methodologies of FIGS. 5 and 6 are shown and described as executing serially, it is to be understood and appreciated that the present invention is not limited by the orders shown, as some aspects may, in accordance with the present invention, occur in different orders or concurrently from that shown and described herein. Moreover, not all features shown or described may be needed to implement a method in accordance with the present invention. Additionally, such methods can be implemented in hardware (e.g., analog circuitry, digital circuitry or a combination thereof), software (e.g., running on a DSP, state machine or ASIC) or a combination of hardware and software.

FIG. 5 depicts an example of a method that can be implemented by a tire pressure sensing module to facilitate identification of the module within a TPMS. The method begins at 200 such as in conjunction with powering up the device or otherwise activating the module for operation within a tire. The module can include a plurality of operating modes, including a learning mode that is employed to program an associated central system with identification information associated with one or more modules in the TPMS. At 210, a determination is made as to whether a signal has been received. This determination can be made by operating a corresponding low power receiver (e.g., an envelope detector) in a continuous mode to monitor for signals received at an associated antenna. If a signal is not received, the receiver circuit can maintain the low power consumption and continuously monitor for a signal. If a signal is received (YES), the method proceeds to 220.

At 220, a corresponding signal is converted, such as to an envelope representation thereof. For example, the conversion can include a rectification of the receive signal to a corresponding voltage level shifted representation that varies as a function of the amplitude of the received signal. At 230, a determination is made as to whether the converted signal exceeds a predetermined amplitude level. This determination can be made for example, by comparing the converted signal relative to a voltage threshold that can be set to a sufficiently high level to mitigate erroneous operation of the detection method. The determination at 230 can include a plurality of different thresholds, such as to perform data slicing on the converted signal and, in turn, provide a corresponding digital signal with one or more bits being asserted based on the amplitude level of the converted signal (at 220). If the converted signal does not exceed the amplitude level (NO), the method returns to 210. If the converted signal does exceed the predetermined amplitude level (YES), corresponding to a high power transmission received by an associated receive detector, the method proceeds to 240.

At 240, a corresponding trigger is generator. The trigger can be generated as a control signal that instructs a control system of the module that a corresponding signal has been received corresponding to activation of the learning mode and requiring transmission by the module of appropriate identifying data. The trigger signal can be a single bit or multi-bit signal, depending on the type of data slicing or analog-to-digital conversion implemented in connection with the determination at 230. At 250, a transmitter is activated to transmit appropriate identifying data via the same antenna employed to receive the signal at 210. The transmitted signal can also include other sensor condition data (e.g., pressure and/or temperature), if desired. From 250, the method returns to 210 in which the receiver maintains is low power operation in the continuous mode receiving for additional signals.

FIG. 6 depicts an example of another method that can be utilized for operation of a central control monitoring system according to an aspect of the present invention. The method begins at 300, such as in conjunction with powering up the central system. This can occur, for example, as a function of the ignition key going into the accessory or on mode. At 310, a user input is received, such as through a corresponding input device associated with the central system. At 320, a determination is made as to whether the learning mode has been entered based on the user input at 310. If the learning mode is entered (YES), the method proceeds to 330. At 330, while operating in the learning mode for the central system, instructions are provided to inform a user to activate a corresponding tire pressure sensing module, such as shown and described in FIG. 5. The instructions at 330 can include audio, visual (e.g., text or graphics) or a combination of audio and visual indications.

At 340, a determination is made as to whether a transmit signal has been received from moduleᵢ (where i denotes a given module in the TPMS). If the determination is negative, the method proceeds to 350, which may correspond to a time out function. For example, the learning mode can be entered into for up to a predetermined duration or after all tires have been programmed. If the inflation mode has not timed out (NO), the method returns to 340 to wait for one or more transmit signals from modules. If the transmit signal is received from moduleᵢ (YES), the method proceeds to 360. At 360, identifying data in the associated memory is set for the moduleᵢ based upon the identifying data received in the one or more transmit signals from moduleᵢ. It is to be appreciated that the central system can receive signals from the modules in the TPMS at a single antenna or, alternatively at a separate antennas that are associated with each respective tire and moduleᵢ. When multiple antennas are utilized in the central system, the associated control process can determine whether a received signal originated from the tire specified in the instructions to the user or as otherwise required during the learning mode.

At 370, a determination is made as to whether any additional modules are to be programmed in the learning mode. If additional modules do exist (YES), the method proceeds to 380 in which the process advances to a next modules (i=i+1) for programming corresponding identifying data. From 380, the method returns to 330 and provides appropriate instructions (e.g., audio, visual or audio-visual) to inform the user to manually activate the next moduleᵢ. This process can be repeated until each of the respective modules has been appropriately programmed in the associated control and monitoring system. Thus, after no additional modules exist at 370 (NO) or if the learning mode times out at 350, the method proceeds to 390 in which the learning mode is ended. From 390 the method returns to 310 to wait for additional user input instructions. During this time, the system method can also remain in a normal operating mode or some other mode, such as is known in the art.

At 320, if the user input instructions do not correspond to entering the learning mode (NO), the method can proceed to 400 to determine an additional operating mode. In the example of FIG. 6, one additional mode corresponds to an inflation mode. Thus at 400, if a determination is made that the user input instructions at 310 are to enter the inflation mode (YES), the method proceeds from 400 to 410. At 410, a high power broadcast signal can be transmitted from the central controlling monitor system for receipt by the associated tire pressure modules. The high power broadcast signal can be of a predefined duration that is detected by the respective modules to cause the modules to enter a corresponding inflation mode. Alternatively, sufficient data or a predetermined series of high power pulses can be provided in the high power signal that provides instructions to cause the remote modules to enter the inflation mode. The high power signal is utilized to enable a sufficiently high amplitude signal to be received by one or more associated receive detectors for activating the respective modules in the TPMS. As yet another alternative, a signal can be transmitted from a remote keyless entry fob positioned in sufficiently close proximity to each tire pressure module to cause each of the respective modules to enter the corresponding inflation mode in response to the transmission.

From 410, the method proceeds to 420 in which the received signals are monitored by the central module. Each of the received signals includes identifying data and tire condition data that can be displayed or otherwise utilized to assist the user in inflating the tires to an appropriate pressure, such as can be indicated at 430. The indication at 430 can include audio or visual, or a combination of audio and visual, such as mentioned above. At 440, a determination is made whether to end the inflation mode, such as based on a user input received via an input device or based on a mode timer (not shown) timing out. If the inflation mode has not been ended (NO), the method proceeds to 420. After a determination is made to end the inflation mode at 440 (YES), the method proceeds to 390 to end the corresponding mode. Those skilled in the art will understand and appreciate various other mechanisms that can be utilized to bring the method out of the inflation mode or into other modes. Additionally, it will be appreciated that more than one operating mode can be implemented concurrently.

Back at 400, if the user input received at 310 is not to enter the inflation mode but may correspond to another mode, the method may proceed from 400 to 450 to enter one or more other corresponding modes. Those skilled in the art will appreciate various other operating modes that may be implemented by a central control and monitoring system. The other mode(s) at 450 has been provided in FIG. 6, by way of example, to demonstrate that one or more additional modes can be utilized by the central control monitoring process.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A tire pressure sensing module, comprising:
a receive detector coupled to monitor a radio-frequency signal received by an antenna, the receive detector providing a detection signal if the radio-frequency signal has at least a predetermined amplitude;
at least one sensor operative to sense a condition associated with a tire;
a transmitter coupled to provide a transmit signal via the antenna; and
a control system that controls the transmitter to transmit the transmit signal to include at least the identifying data in response to the detection signal.

2. The module of claim 1, further comprising a portable transmitter that transmits the radio-frequency signal received by the antenna, the predetermined amplitude being set to require that portable transmitter be within a predetermined distance relative to the antenna to enable the receive detector to provide the detection signal.

3. The module of claim 2, wherein the predetermined distance is substantially less than one-half the distance to a closest adjacent other tire pressure sensing module.

4. The module of claim 2, wherein the portable transmitter further comprises a fob for a keyless entry system.

5. The module of claim 1, wherein the radio-frequency signal and the transmit signal are ultra high frequency (UHF) signals.

6. The module of claim 5, wherein the transmitter and the receive detector share a common antenna.

7. The module of claim 1, wherein the receive detector further comprises an envelope detector that provides a voltage-shifted representation of the radio-frequency signal, the detection signal varying based on the voltage-shifted representation of the radio-frequency signal.

8. The module of claim 7, further comprising a data slicer that converts the voltage-shifted representation of the radio-frequency signal to a corresponding digital signal that defines the detection signal, the control system controlling the transmitter based on a value of the corresponding digital signal.

9. The module of claim 7, wherein the envelope detector further comprises a diode detector.

10. The module of claim 1, wherein the receive detector operates in a continuous mode to receive the radio-frequency signal, the control system waking up in response to the detection signal having a value that indicates initiation of a learning mode for the module.

11. The module of claim 1, wherein the transmit signal includes at least the identifying data and data indicative of the condition associated with the tire in response to the detection signal.

12. A tire pressure monitoring system comprising:
a plurality of tire pressure sensing modules, each according to claim 1, each of the plurality of tire pressure sensing modules having different identifying data and being responsive to the radio-frequency signal received by the antenna thereof, and
a central control system that receives signals transmitted from each of the plurality of tire pressure sensing modules and, when in a learning mode, sets identifying data for each of a plurality of tires of a vehicle based on signals transmitted from each respective one of the plurality of tire pressure sensing modules.

13. The tire pressure monitoring system of claim 12, wherein the receive detector of each of the plurality of tire pressure sensing modules further comprises an envelope detector that provides a voltage-shifted representation of the radio-frequency signal, the transmitter of a given one of the plurality of tire pressure sensing modules being activated to transmit to the central control system if the radio-frequency signal has at least the predetermined amplitude.

14. A tire pressure monitoring system comprising:
a plurality of tire pressure sensing modules, each of the plurality of tire pressure sensing modules comprising:
a receive detector that provides a detection signal if a radio frequency signal received by an associated antenna has at least a predetermined amplitude;
at least one sensor operative to sense a condition associated with a tire;
a transmitter coupled to provide a transmit signal for radio-frequency transmission via the antenna; and
a control system that controls the transmitter to transmit the transmit signal to include at least the identifying data in response to the detection signal;
a central system comprising:
a receiver that receives the transmit signal from each of the plurality of tire pressure sensing modules; and
memory that stores identifying data associated with of vehicle tires during a learning mode based on the transmit signal received from each of the plurality of tire pressure sensing modules.

15. The system of claim 14, wherein the receive detector of each of the plurality of tire pressure sensing modules further comprises an envelope detector that provides a voltage-shifted representation of the radio-frequency signal, the detection signal for each of the plurality of tire pressure sensing modules varying based on the voltage-shifted representation of the radio-frequency signal.

16. The system of claim 15, wherein the receive detector of each of the plurality of tire pressure sensing modules further comprises a data slicer that converts the voltage-shifted representation of the radio-frequency signal to a corresponding digital signal that defines the detection signal.

17. The system of claim 14, further comprising a portable transmitter that transmits the radio-frequency signal received by the antenna of each of the plurality of tire pressure sensing modules, the predetermined amplitude being set to require that portable transmitter be within a predetermined distance relative to the antenna of each of the plurality of tire pressure sensing modules to enable the receive detector thereof to provide the detection signal with a value that causes the transmitter to provide the transmit signal to the central system.

18. The system of claim 17, wherein the predetermined distance is substantially less than one-half the distance to a closest adjacent other one of the plurality of tire pressure sensing modules.

19. A system to facilitate identifying a tire pressure sensing module in a tire pressure monitoring system, comprising:
means for receiving a signal at a tire pressure sensing module that is operative to sense a condition of a tire;
means for transmitting identifying data from the tire pressure sensing module in response to the received signal having at least about a predetermined amplitude indicating operation in a learning mode;
means for receiving the transmitted identifying data at a central system of the tire pressure monitoring system; and
means for storing an indication of the identifying data associated with the tire based on the identifying data received from the tire pressure sensing module.

20. A method to facilitate identifying a tire pressure sensing module in a tire pressure monitoring system, the method comprising:
receiving a signal at a tire pressure sensing module that is operative to sense a condition of at least one tire;
transmitting identifying data by the tire pressure sensing module if the received signal has at least a predetermined amplitude corresponding to a learning mode;
receiving the transmitted identifying data at a central monitoring system; and
setting an indication of the identifying data as being associated with the at least one tire based on the identifying data received from the tire pressure sensing module.

21. The method of claim 20, further comprising:
detecting an envelope of the signal received at the tire pressure sensing module; and
providing a detection signal based on the detected envelope of the signal received at the tire pressure sensing module, the identifying data being transmitted in response to the detection signal having a value corresponding to the learning mode.

22. The method of claim 20, further comprising implementing an inflation mode at each of the plurality of tire pressure sensing modules in the tire pressure monitoring system in response to a receive detector of each of the plurality of tire pressure sensing modules receiving a high power signal corresponding to the inflation mode.

23. The method of claim 20, further comprising generating a trigger in response to the received signal having at least the predetermined amplitude, the transmission of the identifying data by the tire pressure sensing module occurring in response to the trigger.
